(19) United States
(12) Patent Application Publication
(10) Pub. No.: US 2026/0002802 A1
(43) Pub. Date: Jan. 1, 2026

(54) METHOD FOR DETERMINING A FLOW-RATE-DEPENDENT MEASURED VARIABLE

(71) Applicant: Endress+Hauser Flowtec AG, Reinach (CH)

(72) Inventors: Simon Mariager, Basel (CH); Simon Triebenbacher, Basel (CH); Markus Rüfenacht, Diepflingen (CH); Tulio Paiva Galvao, Schopfheim (DE); Michael Burger, Seuzach (CH)

(21) Appl. No.: 19/100,251

(22) PCT Filed: Jul. 17, 2023
(86) PCT No.: PCT/EP2023/069822

§ 371 Date: Jan. 31, 2025

(30) Foreign Application Priority Data
Aug. 25, 2022 (DE) 10 2022 121 564.4

(51) Int. Cl. G01F 1/58

(52) U.S. Cl. CPC G01F 1/586; G01F 1/584

(57) ABSTRACT

A method for determining a flow-rate-dependent measured variable for a flowable medium in a process line using a magnetically inductive flowmeter or a magnetically inductive flow measurement probe, wherein the process line has a process line section that is in contact with the medium and that adjoins an end face of the magnetically inductive flowmeter, comprises determining at least one process-line-specific criterion related to an influence of a character of the process line, in particular of the process line section, on the electrical potential distribution in the process line section; and determining the flow-rate-dependent measured variable, wherein the process-line-specific criterion is used to determine the flow-rate-dependent measured variable. Also disclosed is a magnetically inductive flowmeter and a magnetically inductive flow measurement probe.

The invention relates to a method for determining a flow-rate-dependent measured variable, to a magnetically inductive flowmeter and to a magnetically inductive flow measurement probe.

Magnetically-inductive flowmeters are used for determining the flow rate and the volumetric flow of a flowing medium in a pipe. A distinction is made here between in-line magnetically-inductive flowmeters and magnetically-inductive flow measurement probes, which are inserted into a lateral opening of a pipe. A magnetically-inductive flowmeter has a magnetic-field-generating device for generating a magnetic field. A main axis of the magnetic field runs essentially perpendicular to the flow direction of the flowing medium. Saddle coils or solenoids are usually used for this purpose. In order to realize a predominantly homogeneous magnetic field, pole shoes are additionally formed and attached relative to the flow direction such that the magnetic field lines run over the entire tube cross-section essentially perpendicular to the transverse axis or in parallel with the vertical axis of the measuring tube. In addition, a magnetically-inductive flowmeter has a measuring tube on the outer lateral face of which the magnetic-field-generating device is arranged. A pair of measurement electrodes attached to the lateral surface of the measuring tube taps a measurement voltage or potential difference which is perpendicular to the direction of flow and to the magnetic field and arises when a conductive medium flows in the direction of flow when the magnetic field is applied. Since, according to Faraday's law of induction, the tapped measurement voltage depends on the velocity of the flowing medium, the flow rate and, with the inclusion of a known pipe cross-section, the volumetric flow can be determined from the induced measurement voltage.

In contrast to a magnetically-inductive flowmeter, which comprises a measuring tube for conducting the medium with an attached device for generating a magnetic field penetrating the measuring tube and which also comprises measurement electrodes, magnetically-inductive flow measurement probes are inserted with their usually circular cylindrical housings into a lateral opening of a pipe and fastened in a fluid-tight manner. A special measuring tube is no longer necessary. The measurement electrode arrangement and coil arrangement, mentioned at the outset, on the lateral surface of the measuring tube are omitted and are replaced by a device for producing a magnetic field, which device is arranged in the interior of the housing and in direct proximity to the measurement electrodes and is designed such that an axis of symmetry of the magnetic field lines of the produced magnetic field perpendicularly intersects the front face or the face between the measurement electrodes. In the prior art, there is already a plurality of different magnetically-inductive flow measurement probes.

Magnetically-inductive flowmeters are often used in process and automation engineering for fluids, starting from an electrical conductivity of approximately 5 μS/cm. Corresponding flow measurement devices are sold by the applicant in a wide variety of embodiments for various fields of application, for example under the names PROMAG or MAGPHANT.

Efforts are being made to make magnetically-inductive flowmeters more compact and to reduce the length of the measuring tube in the longitudinal direction to the shortest length possible. However, this is accompanied by a measurement error in the measured flow, which can vary from measuring point to measuring point (1 to 5 percent). This measuring-point-dependent measurement error also occurs with magnetically-inductive flow measurement probes.

The object of the invention is to remedy this problem.

The object is achieved by the method according to claim 1, the method according to claim 2, the magnetically-inductive flowmeter according to claim 14 and by the magnetically-inductive flow measurement probe according to claim 15.
The method according to the invention for determining a flow-rate-dependent measured variable for a flowable medium in a process line by means of a magnetically-inductive flowmeter,
wherein the process line has a process line section that is in contact with the medium and adjoins an end face of the magnetically-inductive flowmeter,
wherein the magnetically-inductive flowmeter comprises a measuring tube for guiding the medium, a magnetic-field-generating device for generating a magnetic field that passes through the measuring tube and at least one measurement electrode for determining a measurement voltage induced in the medium,
   comprises the method steps:
   determining at least one process-line-specific criterion,
wherein the process-line-specific criterion is related to the influence of a character of the process line, in particular of the process line section, on an electrical potential distribution, in particular in the direction of flow of the medium, in the process line section; and
   determining the flow-rate-dependent measured variable,
wherein the process-line-specific criterion, in particular a criterion-specific variable assigned to the process-line-specific criterion, is included in the determination of the flow-rate-dependent measured variable.

The advantage of the design is that, by taking into account the process line and its influence on the electrical potential distribution in the flowing medium when determining the flow-rate-dependent measured variable, the measuring-point-dependent measurement error is reduced and magnetically-inductive flowmeters can thus be more compact without the need to accept any loss in measurement accuracy. It has been found that the measuring-point-dependent measurement error can be corrected by taking the process-line-specific criterion into account. The customer or the fitter only needs to specify the process-line-specific criterion valid at the measuring point provided in the magnetically-inductive flowmeter (e.g. at commissioning) or select it from a predefined list in the controller of the magnetically-inductive flowmeter. A correction variable, i.e. a correction factor and/or a correction offset, is assigned to the selected process-line-specific criterion, or the criterion-specific variable is a correction factor and/or a correction offset which takes into account the process-line-related electrical potential distribution and its influence on measurement.

The use of electrically conductive grounding disks on the end face between the magnetically-inductive flowmeter and the process line is known from the prior art. These serve to set a controlled electrical potential in the flowing medium and to prevent a shift of the zero point of the measurement voltage induced in the medium. However, this solution is very costly, especially for large nominal diameters and special applications in which corrosion can occur. An advantage of the present solution is therefore the use of the magnetically-inductive flowmeter without the need for grounding disks.

The process-line-specific criterion is a feature of the process line that influences the electrical potential distribution in the longitudinal direction of the flowing medium. The electrical potential distribution results from the local course of the electrical potential in a longitudinal section through the process line and the magnetically-inductive flowmeter.
The method according to the invention for determining a flow-rate-dependent measured variable of a flowable medium in a process line by means of a magnetically-inductive flow measurement probe,
wherein the process line has a process line section that is in contact with the medium and in which an opening is arranged,
wherein the magnetically-inductive flow measurement probe is arranged in the opening,
wherein the magnetically-inductive flow measurement probe comprises a housing that is in contact with the medium, a magnetic-field-generating device for generating a magnetic field that passes through the housing, and at least one measurement electrode for determining a measurement voltage induced in the medium,
   comprises the method steps:
   determining at least one process-line-specific criterion,
wherein the process-line-specific criterion is related to the influence of a character of the process line, in particular of the process line section, on an electrical potential distribution, in particular in the direction of flow of the medium, in the process line section; and
   determining the flow-rate-dependent measured variable,
wherein the process-line-specific criterion, in particular a criterion-specific variable assigned to the process-line-specific criterion, is included in the determination of the flow-rate-dependent measured variable.

The advantage of the design is that, taking into account the process line and its influence on the electrical potential distribution in the flowing medium when determining the flow-rate-dependent measured variable significantly increases the possible applications for magnetically-inductive flow measurement probes. This means that magnetically-inductive flow measurement probes can be used simultaneously in process lines made of metal and process lines made of plastic without needing to be recalibrated. Another advantage is that a single adjustment is sufficient, for example in a process line made of metal. Even if the magnetically-inductive flow measurement probe is subsequently used in a process line made of plastic.

Advantageous embodiments of the invention are the subject-matter of the dependent claims.
One embodiment provides that the criterion-specific variable is or will be determined by means of a simulation method, in particular a numerical one,
wherein the process-line-specific criterion is included in the simulation method.

The use of numerical simulation methods to create flow simulations is already known and is already used for designing magnetically-inductive flowmeters and magnetically-inductive flow measurement probes. Navier-Stokes equations, Euler equations, Stokes equations or potential equations are usually used for this purpose. Numerical simulation methods eliminate the need for experiments with flowing media and experimentally testing a plurality of potential measuring points. U.S. Pat. No. 11,199,436 B2 discloses a magnetically-inductive flowmeter in which by means of the finite element method and computational flow dynamics (CFD) certain correction factors are stored in order to correct measurement errors caused by disturbances (pipe elbow, valve, etc.) on the inlet and/or outlet side. The aforementioned disturbances result in an asymmetric flow profile and the assumption usually made when configuring the magnetically-inductive flowmeter that a completely rotationally symmetrical flow profile is present is no longer valid. However, the present invention is to be distinguished from the cited prior art, since the present solution does not take into account the influence of the process line on the flow profile in the measuring tube, but rather the influence on the electrical potential distribution present in the medium and in particular its local course in the direction of flow.

The numerical simulation method is not only suitable for simulating the electrical potential distribution in the medium for a given process-line-specific criterion but also for determining the criterion-specific variable which the user can use to correct the measurement error.

The criterion-specific variable can be stored in a memory of the magnetically-inductive flowmeter or of the magnetically-inductive flow measurement probe or can be provided via a wired or wireless connection to an external computing system, where it is determined.
One embodiment provides that the simulation method involves a calculation using the finite element method.
One embodiment provides that no flow simulation is used to determine the criterion-specific variable.

The finite element method is a numerical simulation method and is commonly used in strength and deformation investigations of solids. According to the invention, it is not the flow profile of the flowing medium that is simulated by means of the finite element method but the process line, the individual components of the magnetically-inductive flowmeter or of the magnetically-inductive flow measurement probe, or the magnetic field distribution generated thereby, the medium itself and the distribution of the electrical potential in the medium.
One embodiment provides that the, in particular numerical, simulation method involves determining the electrical potential distribution, in particular in the direction of flow of the medium, in the process line, in particular in the process line section, and/or in the magnetically-inductive flowmeter,
wherein a difference between the determined potential distribution and a prespecified potential distribution is included in the determination of the criterion-specific variable.

By means of the simulation method, the electrical potential present in the medium is determined in at least one longitudinal section through the process line and/or the magnetically-inductive flowmeter. This results in an electrical potential distribution which takes into account the properties of the process line and/or of the magnetically-inductive flowmeter, in particular the electrical properties. The determination is carried out for a reference system and for different measuring points, each of which differ with respect to the process-line-specific criterion. If the measuring point has, for example, an electrically conductive process line, the electrical potential in the process line section adjoining the magnetically-inductive flowmeter is set to zero. If the process line is electrically insulating or has an electrically insulating coating, the surface of the process line in contact with the medium will have an infinitely high resistance or a very high resistance relative to the electrical resistance of a metal pipe (several orders of magnitude greater). The reference system can be the calibration measuring point present during calibration of the magnetically-inductive flowmeter or of the magnetically-inductive flow measurement probe. The difference between the potential distributions of the reference system and of the measuring point is included in the final criterion-specific variable.
One embodiment provides that the simulation method involves determining a weight function at least in one measurement electrode cross-section,
wherein a difference between the determined weight function and a given weight function is included in the determination of the criterion-specific variable,
wherein the measurement electrode cross-section intersects the at least one measurement electrode.

Alternatively or additionally, the simulation method can be used to determine the weight function in the measurement electrode cross-section, which provides information about the measurable induced voltage present at the measurement electrodes. When determining the weight function, a summation or integration is performed over the local potential distribution in the measuring electrode cross-section. The individual electrical potentials are dependent on the potential distribution in the direction of flow. The weight function is also determined for a reference system and for the corresponding measuring points. A difference between the two weight functions is included in the criterion-specific variable.
One embodiment provides that the process-line-specific criterion corresponds to at least one criterion from the following list:
the process line is electrically conductive;
the process line is electrically insulating;
the process line is electrically insulating and a grounding ring is arranged between the process line and the magnetically-inductive flowmeter;
the process line is electrically insulating and no grounding ring is arranged between the process line and the magnetically-inductive flowmeter;
an electrically insulating coating is present in the process line, in particular in the process line section;
carrying a medium containing deposit-forming substances;
the process line has an electrically insulating process-line liner;
the process line has an inner diameter that differs from the inner diameter of the measuring tube.

The specified criteria are not necessarily stored in the measuring device as formulated above, but analogously thereto. It is clear from the list that the electrical properties of the part of the process line that is in contact with the medium play an important role here. As shown in the list, a criterion can also include two or more features of the process line.
One embodiment provides that the process-line-specific criterion includes the material that the process line section of the process line, in particular a process line body of the process line, comprises.

The material of the process line walls typically comprises metal, glass, cement, plastic, ceramic, enamel and/or GRP.
One embodiment provides that the process-line-specific criterion includes an inner diameter of the process line.

Even though there are standards for the nominal diameters of pipes and process lines, deviations from the standard can still occur. For example, the inner diameter of the process line often does not match the inner diameter of the magnetically-inductive flowmeter, resulting in an offset at the transition between the process line and the magnetically-inductive flowmeter. This offset can result in a shift in the electrical potential distribution, which results in a shift in the calibration factor or leads to an offset of the measured values (zero point shift). If the offset is known, a criterion-specific variable associated with the offset can be used to correct the zero point shift.
One embodiment provides that the magnetically-inductive flowmeter comprises an electrical device potential,
wherein the process-line-specific criterion includes whether the magnetically-inductive flowmeter or the magnetically-inductive flow measurement probe is operated in an ungrounded mode,
wherein the ungrounded mode comprises the operation of the magnetically-inductive flowmeter or of the magnetically-inductive flow measurement probe with galvanic isolation of the medium from the device potential.

Correct potential equalization is a prerequisite for stable, reliable flow measurement. Insufficient or faulty potential equalization can lead to device failure and pose a safety risk. To ensure perfect measurement, it should be noted that the medium, the sensor and the transmitter must in principle be at the same electrical potential. A required potential-equalizing connection can be made by means of a grounding cable with a minimum cross-section of 6 mm².

In the case of a metal, grounded process line without lining, the potential is equalized via the measuring tube of the magnetically-inductive flowmeter. If the process line is properly grounded on both sides, the medium will be at the same electrical potential as the process line, since the process line wall that is in contact with the medium is electrically conductive. The medium is thus set to ground potential.

If the process line includes a pipe made of plastic or an electrically insulating lining that comes into contact with the medium, the potential will be equalized via grounding terminals and grounding disks.

In the case of an ungrounded mode, the potential of the material to be measured may differ from the potential of the measuring device. The “ungrounded mode” makes possible a galvanic isolation of the measuring system from the device potential. In this way, harmful compensating currents caused by potential differences between the measuring media and the device can be minimized. The voltage differences between the potential of the material to be measured and the device potential should be as small as possible and usually lie in the mV range. If the pipe is made of plastic and the sensor and the transmitter are properly grounded, a potential difference between the medium and the protective ground can occur, i.e. compensating currents through the medium cannot be ruled out. Potential equalization between the potential of the medium and the protective ground via the reference electrode is minimized in the ungrounded mode.
One embodiment provides that a calibration factor K is included in the determination of the flow-rate-dependent measured variable,
wherein the calibration factor K is determined by means of a calibration procedure.
One embodiment provides that the criterion-specific variable is determined by a distance between the magnetic-field-generating device and the process line, in particular the process line section, or a length of the measuring tube.
One embodiment provides that the criterion-specific variable is determined by a distribution-specific variable, in particular a half-value width, of the magnetic field.

As the measuring tube length is reduced, the magnetic field generated by the magnetic-field-generating device increasingly overlaps the process line section adjoining the magnetically-inductive flowmeter. This leads to the charges in the flowing medium already being separated in the process line. The disadvantage of this is that the electrical properties present in the process line are not known and thus leads to an incorrect offset in the flow-rate-dependent measured variable.

The distribution-specific variable of the magnetic field generated by the magnetic-field-generating device can be determined by means of a simulation method or measured at the factory during calibration of the magnetically-inductive flowmeter or of the magnetically-inductive flow measurement probe. The measurement can be carried out using commercially available magnetic field sensors. The finite element method is likewise a suitable simulation method.
One embodiment provides that the criterion-specific variable is not dependent on a maximum magnetic field strength of the magnetic field generated.

Surprisingly, it has been found that the criterion-specific variable does not correlate with the maximum magnetic field strength of the magnetic field generated, but depends strongly on the distribution, in particular the half-value width, of the magnetic field.
One embodiment provides that the method according to the invention comprises the method steps of:
the user specifying the process-line-specific criterion;
the manufacturer calculating the criterion-specific variable on the basis of the specified process-line-specific criterion;
the manufacturer providing the user with the criterion-specific variable;
optionally: the user selecting the process-line-specific criterion on the magnetically-inductive flowmeter or on the magnetically-inductive flow measurement probe.

As an alternative to the conventional storage of prefabricated lists containing criteria and correspondingly assigned criterion-specific variables or correction variables, it is advantageous if the user in order to determine the criterion-specific variable describes his process-line-specific criterion himself and sends it to the manufacturer. This can be done informally as a voice message, text or with the aid of a software program that is designed to guide the user in such a way that all necessary information is provided. Once all the information has been received, the criterion-specific variable is then calculated by the manufacturer and then provided for the user. The criterion-specific variable can be transferred directly from the manufacturer to the magnetically-inductive flowmeter or to the magnetically-inductive flow measurement probe or transmitted to the user, who then enters the criterion-specific variable into the corresponding measuring device. This has the advantage that not all possible measuring points have to be simulated, but rather on a needs-specific basis. This also has the advantage that the measuring point or the specific process line provided can be included in the simulation in more detail and the criterion-specific variable can be determined more precisely.
The magnetically-inductive flowmeter according to the invention is characterized in that the magnetically-inductive flowmeter is designed to carry out the method according to the invention.
The magnetically-inductive flow measurement probe according to the invention is characterized in that the magnetically-inductive flow measurement probe is designed to carry out the method according to the invention.

The basic concept when determining the flow-rate-dependent measured variable is to take into account the electrical charge distribution in the medium resulting from the process line. The necessary correction variable (i.e. the criterion-specific variable) is preferably determined using a simulation method. Simulation methods in which the geometry of the process line and the resulting flow profile of the flowing medium are simulated are the prior art. In the present invention, the electrical properties of the process line are essentially included in the determination of the correction variable. Using the correction variable determined by means of simulation methods, measuring-point-dependent measurement errors can be minimized.

The invention is explained in greater detail with reference to the following figures. In the drawings:

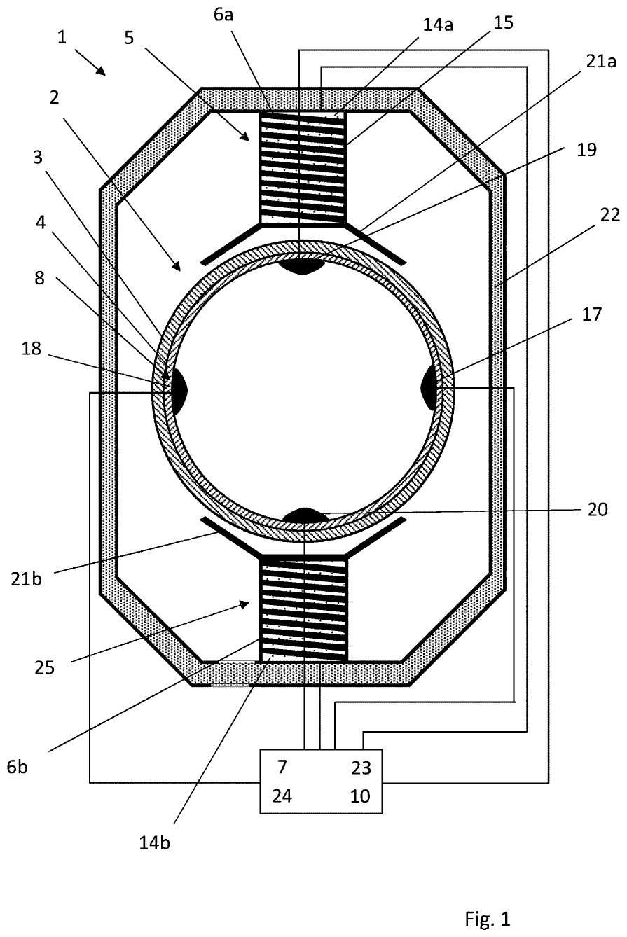

FIG. 1: shows an embodiment of the magnetically-inductive flowmeter according to the invention;

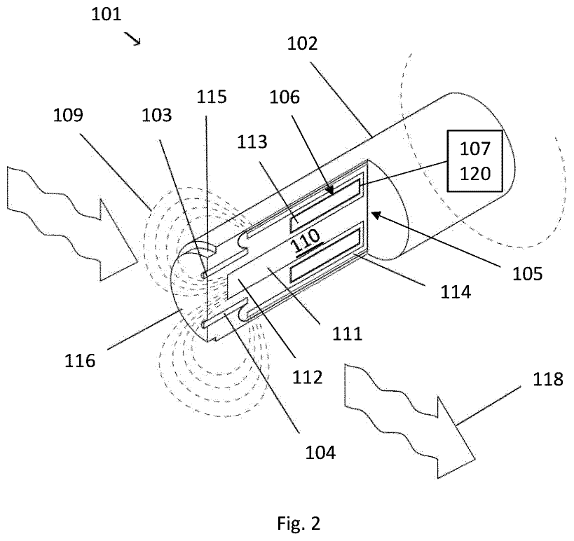

FIG. 2: shows a perspective view of a partially sectional embodiment of a magnetically-inductive flow measurement probe according to the invention;

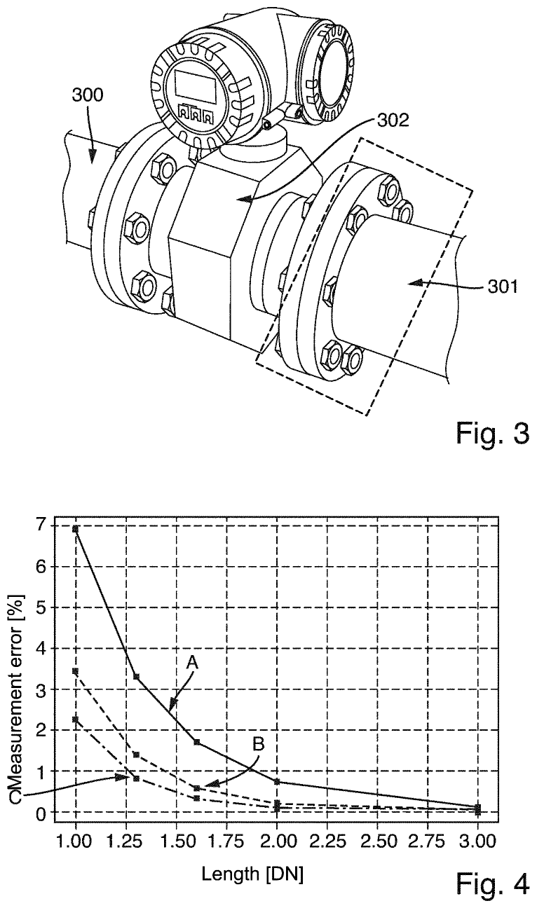

FIG. 3: shows a perspective view of a magnetically-inductive flowmeter installed in a process line;

FIG. 4: shows the relationship between the measurement error and the measuring tube length for different magnetic field distributions; and

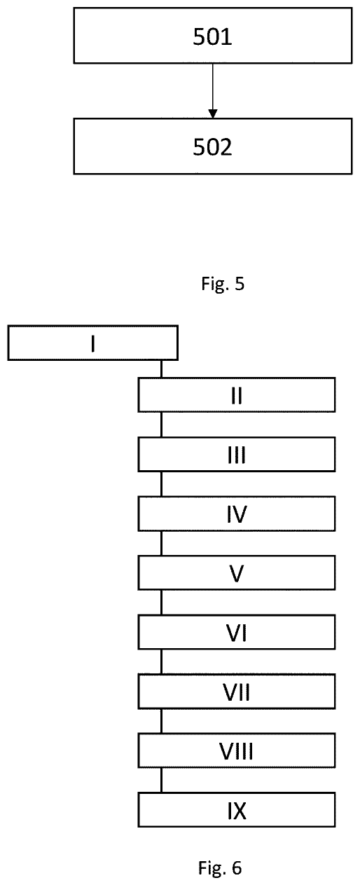

FIG. 5: shows an embodiment of the method according to the invention; and

FIG. 6: shows a menu structure for operating the magnetically-inductive flowmeter or the magnetically-inductive flow measurement probe.

FIG. 1 shows a cross-section of an embodiment of the magnetically-inductive flowmeter 1 according to the invention, in particular the sensor. The structure and measuring principle of a magnetic-inductive flow meter 1 are known in principle. A flowable medium having an electrical conductivity is conducted through a measuring tube 2. The measuring tube 2 comprises a carrier tube 3, which is usually made of, or at least comprises, steel, ceramic, plastic or glass. A magnetic-field-generating device 5 for generating a magnetic field is arranged on the carrier tube 3 such that the magnetic field lines are oriented substantially perpendicularly to a longitudinal direction defined by a measuring tube axis. The magnetic-field-generating device 5 typically comprises a saddle coil or at least one solenoid 6i. A coil core 14i usually extends through a receptacle 15 of the coil 6i. The receptacle 15 is to be understood as the volume which is bounded by the coil wire that forms the coil 6i. The receptacle 15 of the coil 6i can thus be formed by a coil holder or by the imaginary enclosed volume. The latter occurs when the coil wire of the coil 6i is wound directly around the coil core 14i. The coil core 14i is formed from a magnetically conductive, in particular soft, magnetic material. The device 5 for generating the magnetic field comprises a pole shoe 21i which is arranged at one end of the coil core 14i. The pole shoe 21i can be a separate component or can be monolithically connected to the coil core 14i. In the embodiment shown in FIG. 1, two diametrically arranged coils 6a, 6b each have a coil core 14a, 14b and a pole shoe 21a, 21b. The two coil cores 14a, 14b are connected to one another via a field return 22. The field return 22 connects each of the sides of the coil cores 14a, 14b that face away from one another. However, magneto-inductive flowmeters with exactly one coil 6 having exactly one coil core 14 and without a field return are also known. The coil 6 is connected to an operating circuit 7 which operates the coil 6 by means of an operating signal. The operating signal can be a voltage with a time-variable curve and is characterized by operating signal parameters, wherein at least one of the operating signal parameters is controllable. The magnetic field generated by the device 5 for producing the magnetic field is produced by means of a pulsed direct current of alternating polarity provided by an operating circuit 7. This ensures a stable zero point and makes the measurement insensitive to influences due to electrochemical disturbances. The two coils 6a, 6b can be separately connected to the operating circuit 7 or connected in series or in parallel with one another.

When the magnetic field is applied, a flow-rate-dependent potential distribution results in the measuring tube 2, which can be detected, for example, in the form of an induced measurement voltage. A device 8 for tapping off the induced measurement voltage is arranged on the measuring tube 2. In the embodiment shown, the device 8 for tapping off the induced measurement voltage is formed by two oppositely arranged measurement electrodes 17, 18 in order to form a galvanic contact with the medium. However, magnetically-inductive flowmeters are also known, which comprise measurement electrodes arranged on the outer wall of the carrier tube 3 that are not in contact with the medium. The measurement electrodes 17, 18 are generally arranged diametrically and form an electrode axis, or are intersected by a transverse axis which runs perpendicular to the magnetic field lines and the longitudinal axis of the measuring tube 2. However, devices 8 intended for tapping off the induced measurement voltage and having more than two measurement electrodes are also known. The flow-rate-dependent measurement variable can be determined on the basis of the measured measurement voltage. The flow-rate-dependent measurement variable comprises the flow rate, the volumetric flow, and/or the mass flow of the medium. A measuring circuit 23 is configured to detect the induced measurement voltage applied to the measurement electrodes 17, 18, and an evaluation circuit 24 is designed to determine the flow-rate-dependent measured variable. The evaluation circuit 24 can be part of the transmitter.

The carrier tube 3 is often formed from an electrically conductive material such as steel. In order to prevent the measurement voltage applied to the first and second measurement electrodes 2, 3 from being conducted away via the carrier tube 3, the inner wall is lined with an insulating material, for example a liner 4 (made of plastic).

Commercially available magnetic-inductive flow meters have two further electrodes 19, 20 in addition to measurement electrodes 17, 18. In the first case, a fill level monitoring electrode 19 optimally attached at the highest point of the measuring tube 2 serves to detect partial filling of the measuring tube 1 and is configured to pass this information to the user and/or to take into account the fill level when determining the volumetric flow. In addition, a reference electrode 20, which is usually attached diametrically to the fill level monitoring electrode 19 or at the lowest point of the measuring tube cross-section, serves to set a controlled electrical potential in the medium. As a rule, the reference electrode 20 is used to connect the flowing medium to a ground potential.

The operating circuit 7, controller circuit 10, measuring circuit 23 and evaluation circuit 24 can be part of a single electronic circuit or can form individual circuits.

The magnetically-inductive flowmeter 1 is designed to carry out the method according to the invention. For this purpose, the evaluation circuit 24 is designed to incorporate a criterion-specific variable selected from a list directly or indirectly by the operator into the determination of the flow-rate-dependent measured variable. In this way, the measured induced measurement voltage or the measured electrical potentials can be corrected by means of the criterion-specific variable. The evaluation circuit 24 has a microprocessor, logical switching components and/or electronic components for carrying out the method according to the invention.

First, the measuring principle on which the invention is based will be explained on the basis of the perspective and partially sectional illustration in FIG. 2. A flow measurement probe 101 comprises a generally circular cylindrical housing 102 having a predefined outer diameter. Said housing is adapted to the diameter of a hole, which is located in a wall of a tube line (not shown in FIG. 1) and into which the flow measurement probe 101 is inserted in a fluid-tight manner. A medium to be measured flows in the pipe, and the flow measuring probe 101 is immersed into said medium practically perpendicularly to the flow direction of the medium, which is indicated by the wavy arrows 118. A front end 116 of the housing 102 that projects into the medium is sealed in a fluid-tight manner with a front body 115 made of insulating material. By means of a coil arrangement 106 arranged in the housing 102, a magnetic field 109 that extends through the end portion into the medium can be produced. A coil core 111, which at least partially consists of a soft magnetic material and is arranged in the housing 102, terminates at or near the end portion 116. A field return body 114 that surrounds the coil arrangement 106 and the coil core 111 is configured to return, into the housing 102, the magnetic field 109 extending through from the end portion. The coil core 111, the pole shoe 112 and the field return body 114 are each field-conducting bodies 110, which together form a field-conducting arrangement 105. A first and a second measurement electrode 103, 104 forming a galvanic contact with the medium to be conducted form the device for detecting a measurement voltage induced in the medium and are arranged in the front body 115 and, like the outer walls of the housing, touch the medium. A voltage induced due to Faraday's law of induction can be tapped off at the measuring electrodes 103, 104 by means of a measurement and/or evaluation unit. It is at a maximum if the flow measurement probe 101 is installed in the pipe such that a plane spanned by a straight line intersecting the two measurement electrodes 103, 104 and by a longitudinal axis of the flow measurement probe runs perpendicularly to the flow direction 118 or to the longitudinal axis of the pipe. An operating circuit 107 is electrically connected to the coil arrangement 106, in particular to the coil 113, and is configured to impress a clocked operating signal onto the coil 113 in order to thus produce a clocked magnetic field 109.

The magnetically-inductive flow measurement probe 101 is designed to carry out the method according to the invention. For this purpose, the measuring and/or evaluation unit is designed to incorporate a criterion-specific variable selected from a list directly or indirectly by the operator into the determination of the flow-rate-dependent measured variable. For example, the measured induced measurement voltage or the measured electrical potentials can thus be corrected by means of the criterion-specific variable.

FIG. 3 is a perspective view of a magnetically-inductive flowmeter 302 installed in a process line 300. The process line section 301 comprises the region of the process line 300 that is in the immediate vicinity of the connection devices (e.g. flange) of the magnetically-inductive flowmeter 302. The process line section 301 that is in contact with the medium usually also comprises a process line connection device (e.g. flange). Especially in compact magnetically-inductive flowmeters 302, the magnetic field generated extends into the process line section 301. The process line section 301 thus ends where the magnetically-inductive flowmeter 302 begins and the overlapping magnetic field is so small that no separation of the electrical charges occurs in the medium.

FIG. 4 shows the relationship between the measurement error (Y-axis) and the length of the measuring tube (X-axis) for magnetic field distributions with different half-value widths. FIG. 4 shows how the increase in the measurement error is related to the reduction in the length of the measuring tube. Very short measuring tubes (length less than 2 DN) in particular have extreme measurement errors. If the magnetic field distribution of the magnetically-inductive flowmeter has a half-value width of 1.18 times the length of the measuring tube—i.e. the magnetic field strength in the process line section is, at points, greater than half the maximum magnetic field strength—the measurement error increases sharply as the length of the measuring tube decreases, so as to be 7% for a length of 1 DN (see A). If the half-value width of the magnetic field generated is reduced by approximately half, the measurement error will also be reduced by approximately half (see B). If, when designing the magnetically-inductive flowmeter, the magnet system is dimensioned and constructed in such a way that the magnetic field distribution in the longitudinal direction has a half-value width of only approx. ¼ of the length of the measuring tube, even with a measuring tube length of 1 DN, there will still be a measurement error of 1 to 2%. The consequence of this is that it is not sufficient to design the magnetic-field-generating device in such a way that the magnetic field distribution of the magnetic field generated is as narrow as possible.

FIG. 5 shows an embodiment of the method according to the invention for determining a flow-rate-dependent measured variable of a flowable medium in a process line by means of a magnetically-inductive flowmeter or a magnetically-inductive flow measurement probe. The method comprises the method steps 501 and 502.

In a first method step 501, at least one process-line-specific criterion is determined or selected. This is done on-site by the operator at the relevant measuring device or remotely by the manufacturer. The process-line-specific criterion describes the influence of a character of the process line, in particular of the process line section which is in the immediate vicinity of the magnetically-inductive flowmeter or of the magnetically-inductive flow measurement probe, on the electrical potential distribution, in particular in the direction of flow of the medium in a longitudinal section, in the process line section.

If the at least one process-line-specific criterion is selected, a criterion-specific variable assigned to the process-line-specific criterion is determined or specified. The criterion-specific variable can be stored in the measuring device in a memory, for example in the form of a list, or transmitted remotely by the manufacturer. The determined criterion-specific variable is then used in a second method step to determine the flow-rate-dependent measured variable. The criterion-specific variable corrects the measured measurement voltage, which contains an error, or potentials at the measurement electrodes.

The criterion-specific variable (correction variable) is or will be determined by means of an, in particular numerical, simulation method. In the simulation method, the process-line-specific criterion is reproduced as accurately as possible with respect to the measuring point. The finite element method is suitable for simulating the process line, the magnetically-inductive flowmeter or the magnetically-inductive flow measurement probe and the medium. The defined framework conditions then result in an electrical potential distribution, in particular in the direction of flow of the medium, in the process line, in particular in the process line section and/or in the magnetically-inductive flowmeter. If the potential distribution for a reference system and a measuring point are known, a difference between the determined potential distribution and a given potential distribution can be determined. The difference is used in the determination of the criterion-specific variable which is used to correct the measured variables.

Alternatively, a weight function is determined at least in one measurement electrode cross-section which intersects the at least two measurement electrodes, said weight function being a measure of the sum or the integral of all the electrical potentials in the measurement electrode cross-section. The weight function is determined for a reference system and a measuring point at which the process-line-specific criterion is present. A difference between the weight function determined for the measuring point and a weight function given for the reference system is used in the determination of the criterion-specific variable.

Furthermore, the inner diameter of the process line of the measuring point, the shortest distance between the magnetic-field-generating device and the process line, and the length of the measuring tube can be included in the criterion-specific variable or in a distribution-specific variable of the magnetic field generated (e.g. the half-value width). These are usually determined or specified by the manufacturer, but they can also be entered by the operator.

FIG. 6 shows an example of a menu structure via which the operator selects the process-line-specific criterion. Under a menu item (I), the operator accesses a list of process-line-specific criteria (II to VII), from which he can select a process-line-specific criterion or a plurality of process-line-specific criteria.

The list includes, for example:
the process line is electrically conductive (II);
the process line is electrically insulating (III);
the process line is electrically insulating and a grounding ring is arranged between the process line and the magnetically-inductive flowmeter (IV);
the process line is electrically insulating and no grounding ring is arranged between the process line and the magnetically-inductive flowmeter (V);
an electrically insulating coating is located in the process line (VI);
carrying a medium containing substances that form the coating (VII);
the process line has an electrically insulating process line liner (VIII);
the process line has an inner diameter that differs from the inner diameter of the measuring tube (IX).

Alternatively, the operator can be given the opportunity to specify a material for the process line or to select one from a predefined list. The above-mentioned entries can also be made by the manufacturer.

### LIST OF REFERENCE SIGNS

Magnetically-inductive flowmeter 1
Measuring tube 2
Carrier tube 3
Liner 4
Magnetic-field-generating device 5
Coil 6
Operating circuit 7
Device for tapping off an induced measurement voltage 8
Controller circuit 10
Coil core 14
Receptacle of the coil 15
Measurement electrode 17
Measurement electrode 18
Fill-level monitoring electrode 19
Reference electrode 20
Pole shoe 21
Field return 22
Measuring circuit 23
Evaluation circuit 24
Coil arrangement 25
Magnetically-inductive flow measurement probe 101
Housing 102
Measurement electrode 103
Measurement electrode 104
Magnetic-field-generating device 105
Coil arrangement 106
Operating circuit 107
Field-conducting arrangement 108
Magnetic field 109
Field-conducting body 110
Coil core 111
Pole shoe 112
Coil 113
Field return body 114
Front body 115
End section 116
Direction of flow of the medium 118
Controller circuit 120

1-15. (canceled)

16. A method for determining a flow-rate-dependent measured variable for a flowable medium in a process line via a magnetically inductive flowmeter, wherein the process line has a process line section that is in contact with the medium and adjoins an end face of the magnetically inductive flowmeter, wherein the magnetically inductive flowmeter includes a measuring tube for guiding the medium, a magnetic-field-generating device for generating a magnetic field that passes through the measuring tube and at least one measurement electrode for determining a measurement voltage induced in the medium, the method comprising:
determining at least one process-line-specific criterion, wherein the process-line-specific criterion is related to an influence of a character of the process line on an electrical potential distribution in the process line section; and
determining the flow-rate-dependent measured variable,
wherein a criterion-specific variable assigned to the process-line-specific criterion is included in the determination of the flow-rate-dependent measured variable.

17. A method for determining a flow-rate-dependent measured variable of a flowable medium in a process line via a magnetically inductive flow measurement probe, wherein the process line has a process line section that is in contact with the medium and comprises an opening, wherein the magnetically inductive flow measurement probe is arranged in the opening, wherein the magnetically inductive flow measurement probe includes a housing that is in contact with the medium, a magnetic-field-generating device for generating a magnetic field that passes through the housing, and at least one measurement electrode for determining a measurement voltage induced in the medium, the method comprising:
determining at least one process-line-specific criterion, wherein the process-line-specific criterion is related to the influence of a character of the process line on an electrical potential distribution in the process line section; and
determining the flow-rate-dependent measured variable,
wherein a criterion-specific variable assigned to the process-line-specific criterion is included in the determination of the flow-rate-dependent measured variable.

18. The method according to claim 16,
wherein the criterion-specific variable is or will be determined by a simulation method, and wherein the process-line-specific criterion is included in the simulation method.

19. The method according to claim 18,
wherein the simulation method involves a calculation using the finite element method.

20. The method according to claim 19,
wherein the simulation method involves determining an electrical potential distribution in the process line and/or in the magnetically inductive flowmeter,
wherein a difference between the determined potential distribution and a given potential distribution is included in the determination of the criterion-specific variable.

21. The method according to claim 20,
wherein the simulation method involves determining a weight function at least in one measurement electrode cross-section,
wherein a difference between the determined weight function and a given weight function is included in the determination of the criterion-specific variable, and
wherein the measurement electrode cross-section intersects the at least one measurement electrode.

22. The method according to claim 16,
wherein the process-line-specific criterion corresponds to a criterion from the following list
the process line is electrically conductive;
the process line is electrically insulating;
the process line is electrically insulating and a grounding ring is arranged between the process line and the magnetically inductive flowmeter;
the process line is electrically insulating and no grounding ring is arranged between the process line and the magnetically inductive flowmeter;
an electrically insulating coating is located in the process line;
carrying a medium containing substances that form the coating;
the process line has an electrically insulating process line liner;
the process line has a process line inner diameter that differs from a measuring tube inner diameter.

23. The method according to claim 16,
wherein the process-line-specific criterion includes a material that the process line section of the process line includes.

24. The method according to claim 16,
wherein the process-line-specific criterion includes an inner diameter of the process line.

25. The method according to claim 16,
wherein the magnetically inductive flowmeter includes an electrical device potential,
wherein the process-line-specific criterion includes whether the magnetically inductive flowmeter is operated in an ungrounded mode, and
wherein the ungrounded mode involves operating the magnetically inductive flowmeter with galvanic isolation of the medium from the device potential.

26. The method according to claim 16,
wherein the criterion-specific variable is determined by a distance between the magnetic-field-generating device and the process line, or a length of the measuring tube.

27. The method according to claim 16,
wherein the criterion-specific variable is determined by a distribution-specific variable of the generated magnetic field.

28. The method according to claim 27,
wherein the criterion-specific variable is not dependent on a maximum magnetic field strength of the generated magnetic field.

29. A magnetically inductive flowmeter, comprising:
a measuring tube for guiding a medium;
a magnetic-field-generating device for generating a magnetic field that passes through the measuring tube; and
at least one measurement electrode for determining a measurement voltage induced in the medium,
wherein the magnetically inducive flowmeter is configured to:
determine at least one process-line-specific criterion, wherein the process-line-specific criterion is related to an influence of a character of the process line on an electrical potential distribution in the process line section; and
determine a flow-rate-dependent measured variable,
wherein a criterion-specific variable assigned to the process-line-specific criterion is included in the determination of the flow-rate-dependent measured variable.

30. A magnetically inductive flow measurement probe, comprising:
a housing that is in contact with a medium;
a magnetic-field-generating device for generating a magnetic field that passes through the housing; and
at least one measurement electrode for determining a measurement voltage induced in the medium,
wherein the magnetically inductive flow measurement probe is configured to:
determine at least one process-line-specific criterion, wherein the process-line-specific criterion is related to the influence of a character of the process line on an electrical potential distribution in the process line section; and
determine a flow-rate-dependent measured variable,
wherein a criterion-specific variable assigned to the process-line-specific criterion is included in the determination of the flow-rate-dependent measured variable.
